(19) United States
(12) Patent Application Publication
(10) Pub. No.: US 2025/0149911 A1
(43) Pub. Date: May 8, 2025

(54) MOBILE AUTOMATIC SWITCHING POWER BACKUP SYSTEMS AND RELATED METHODS

(71) Applicant: Hubbell Incorporated, Shelton, CT (US)

(72) Inventors: Jason John Ball, Clayton, NC (US); Jefferey Lewis Donner, Manitou Springs, CO (US); Jonathan Joseph Horvath, Knightdale, NC (US)

(21) Appl. No.: 18/938,881

(22) Filed: Nov. 6, 2024

Related U.S. Application Data
(60) Provisional application No. 63/596,535, filed on Nov. 6, 2023.

(51) Int. Cl. H02J 9/06; H02B 1/56

(52) U.S. Cl. CPC H02J 9/06; H02B 1/565

(57) ABSTRACT

Mobile automatic switching power backup systems, power distribution enclosures, and related methods of assembly and use are provided herein. A mobile automatic switching power backup system can include a power distribution enclosure having a frame including a platform and exterior walls that form an enclosure with an interior and an uninterruptible power supply (UPS) unit comprising batteries secured within the interior of the power distribution enclosure, and a control panel within the power distribution enclosure for housing controls of the power backup system. An automatic transfer switch (ATS) unit can be located within the control panel and operably connected to the UPS unit. Electrical connectors can be in operable communication with the ATS unit. One or more heating, ventilation, and air-conditioning (HVAC) units can also be provided within the power distribution enclosure.

### RELATED APPLICATIONS

The presently disclosed subject matter claims the benefit of U.S. Provisional Patent Application Ser. No. 63/596,535, filed Nov. 6, 2023, the disclosure of which is incorporated herein by reference in its entirety.

### TECHNICAL FIELD

The present subject matter relates to mobile automatic switching power backup systems and power distribution enclosures that can be used to house power backup systems to facilitate the mobility of the power backup systems as well as methods related to use and assembly as described herein.

### BACKGROUND

Production events, such as sporting events, concerts, and outdoor theatrical productions that are broadcast on television or operate at outdoor venues can require substantial amounts of power to operate all the production equipment and other electronic equipment. Depending on the venue and the power supply infrastructure at the venue, such events can be vulnerable to power outages that can shut down the production and damage production equipment and other electronic equipment.

As such, a need exists for mobile automatic switching power backup systems that can be easily transported to desired venues where a backup power system can be used to protect a production event against utility power supply loss and any damage cause by such a loss.

### SUMMARY

The present subject matter relates to mobile automatic switching power backup systems and power distribution enclosures that can be used to house power backup systems to facilitate the mobility of the power backup systems. Methods related to the use and assembly of the mobile automatic switching power backup systems and power distribution enclosures disclosed herein are also provided.

Thus, it is an object of the presently disclosed subject matter to provide mobile automatic switching power backup systems and power distribution enclosures as well as methods related thereto. While one or more objects of the presently disclosed subject matter being stated herein, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIGS. 1A, 1B, and 1C illustrate perspective views of an embodiment of a mobile automatic switching power backup system according to present subject matter;

FIG. 2A illustrates a cross-sectional front plan view of the embodiment of the mobile automatic switching power backup system according to FIGS. 1A-1C showing an interior of a power distribution enclosure of the mobile automatic switching power backup system;

FIG. 2B illustrates a cross-sectional side plan view of the embodiment of the mobile automatic switching power backup system according to FIG. 2A showing the interior of the power distribution enclosure of the mobile automatic switching power backup system;

FIG. 2C illustrates a cross-sectional rear plan view of the embodiment of the mobile automatic switching power backup systems according to FIG. 2A showing an interior of a power distribution enclosure of the mobile automatic switching power backup system;

FIG. 2D illustrates another cross-sectional plan view of the embodiment of the mobile automatic switching power backup system according to FIG. 2A showing an interior of a power distribution enclosure of the mobile automatic switching power backup system;

FIG. 2E illustrates a cross-sectional top plan view of the embodiment of the mobile automatic switching power backup system according to FIG. 2A showing an interior of a power distribution enclosure of the mobile automatic switching power backup system;

FIG. 3A illustrates rear plan view of the embodiment of the mobile automatic switching power backup system according to FIG. 2A;

FIG. 3B illustrates a side plan view of the embodiment of the mobile automatic switching power backup system according to FIG. 2A;

FIG. 4 illustrates a side plan view of a tractor trailer truck with embodiments of mobile automatic switching power backup systems according to the present subject matter secured on the trailer of the tractor trailer truck;

FIGS. 5A and 5B illustrate top and bottom perspective views of an embodiment of a platform for a power distribution enclosure of a mobile automatic switching power backup system according to the present subject matter;

FIGS. 6A-6D illustrate perspective views of an embodiment of a frame, platform, and exterior walls of a power distribution enclosure for a mobile automatic switching power backup system according to the present subject matter showing various stages of manufacture;

FIG. 7 illustrates a rear plan view of an uninterruptible power supply (“UPS”) unit used in an embodiment of a mobile automatic switching power backup system according to the present subject matter;

FIG. 8 illustrates a perspective view of an embodiment of automatic transfer switch (“ATS”) unit used in an embodiment of a mobile automatic switching power backup system according to the present subject matter;

FIGS. 9A and 9B illustrate perspective views of embodiments of heating, ventilation, and air-conditioning (HVAC) units used in an embodiment of a mobile automatic switching power backup system according to the present subject matter;

FIG. 10A illustrates a cross-sectional rear plan view of an embodiment of a power distribution enclosure for housing mobile automatic switching power backup systems showing a portion of the embodiment of the HVAC units according to FIG. 2A;

FIG. 10B illustrates a cross-sectional a side plan view showing an interior of the embodiment of a power distribution enclosure according to FIG. 10A showing a portion of the embodiment of the HVAC units according to FIG. 2A;

FIGS. 11A-11E illustrate different perspective views of another embodiment of a mobile automatic switching power backup system according to present subject matter;

FIG. 12 illustrates perspective views of another embodiment of a frame and platform of a power distribution enclosure for a mobile automatic switching power backup system according to the present subject matter;

FIG. 13A illustrates a partial cross-sectional side plan view of an embodiment of a power distribution enclosure that uses the frame and platform shown in FIG. 12 for housing a mobile automatic switching power backup system showing positions for outdoor units of HVAC units for the mobile automatic switching power backup system;

FIG. 13B illustrates a partial cross-sectional rear plan view of an embodiment of a power distribution enclosure that uses the frame and platform shown in FIG. 12 for housing a mobile automatic switching power backup system;

FIG. 14 illustrates a cross-sectional top plan view of an embodiment of a mobile automatic switching power backup system showing an interior of a power distribution enclosure of the mobile automatic switching power backup system showing placement of indoor units of HVAC units and related airflow;

FIG. 15 illustrate perspective views of other embodiments of HVAC units used in an embodiment of a mobile automatic switching power backup system according to the present subject matter;

FIG. 16A illustrates a cross-sectional side plan view of an embodiment of a power distribution enclosure housing the mobile automatic switching power backup systems showing a portion of the embodiment of the HVAC units according to FIG. 14;

FIG. 16B illustrates a cross-sectional rear plan view of an embodiment of a power distribution enclosure housing the mobile automatic switching power backup systems showing a portion of the embodiment of the HVAC units according to FIG. 14;

FIGS. 17A and 17B illustrate graphs of temperatures being taken at heated air inlet and cool air outlet vents of in embodiments of mobile automatic switching power backup systems according to the present subject matter during operation.

Repeat use of reference characters in the present specification and drawings is intended to represent the seam or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only, and is not intended as limiting the broader aspects of the present subject matter, which broader aspects are embodied in exemplary constructions.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

As used herein, the term a “grated metal sheet(s)” means a sheet of metal with apertures therethrough in a random or organized pattern to permit airflow therethrough. Grated metal sheets can include, but are not limited to, expanded metal sheets, perforated metal sheets, metal mesh sheets, or the like.

As used herein, “computing device” means one or more desktop computers, laptop computers, set-top devices, tablet computers, mobile devices, mobile smart devices, smartphones, wearable devices, servers, interactive vehicle computers and/or the like. Such computing devices can also include, but are not limited to, at least one of a mobile smartphone, a personal digital assistant (PDA), a computing tablet, a personal media player, programmable logic controllers, or any like mobile electronic device configured with imaging and/or computing capabilities. In some embodiments, the computing device may be provisioned with a hardware-based processor that is configured to execute software programs or applications.

The present subject matter relates to automatic switching mobile battery backup systems for events, such as sporting events or concerts, traveling theatrical events, or the like. The automatic switching mobile battery backup systems are easily connected to event production equipment to provide safe transition from a utility power supply to power provided by a generator in incidences where a utility power supply failure occurs. The automatic switching mobile battery backup systems can be robust enough to withstand the rigors of varying weather conditions, such as temperatures ranging from about −10° F. to about 110° F. Additionally, the automatic switching mobile battery backup systems can withstand the rigors of periodic transport via truck and forklift. For example, the power backup systems can withstand daily, weekly, or monthly moving and transport by tractor trailer and forklift to intended destinations and/or storage.

The backup power system is housed in a power distribution enclosure, or pod, which is a structure that houses an uninterruptible power supply (“UPS”) unit and an automated transfer switch (“ATS”) unit. The power distribution enclosure of the backup power system can be designed to fit multiple units on a single standard 48 foot flatbed trailer of a tractor-trailer truck, meet transportation weight requirements, and be able to be operated directly from the truck bed or be easily forklifted into any position where backup power is needed. For example, in some embodiments, the dimensions of the power distribution enclosure can be such that up to 8 units can be fit on a single standard trailer. In some embodiments, the dimensions of the power distribution enclosure can be such that up to 6 units can be fit on a single standard trailer. For example, in some embodiments, the power distribution enclosure can be about 4 feet wide by about 8 feet deep by about 8 feet tall so that the power distribution enclosure fits on a standard flatbed trailer and remains under transportation height restrictions.

The backup power system can provide up to about 8 to about 10 minutes of backup power output of 200 A-400 A at 208 V or 480V. The backup power system can accept utility and generator inputs and can automatically detect utility power failure and send generator start signal. Thus, the ATS unit in the backup power system can monitor power from a utility power supply and switch the power supply to the UPS unit to provide uninterruptible power if the utility power supply fails until a generator is engaged and up to load at which time the ATS unit switches to the power supplied by the generator.

The power distribution enclosure can be built utilizing structural steel and container materials, such as weathering steel sheet, which can be corrugated to provide a tough steel envelope to prevent damage to interior electrical components, such as the controls in the control panel, the ATS unit and the UPS unit. The unit's weight and center of gravity can be optimized to make the unit easily liftable and transportable.

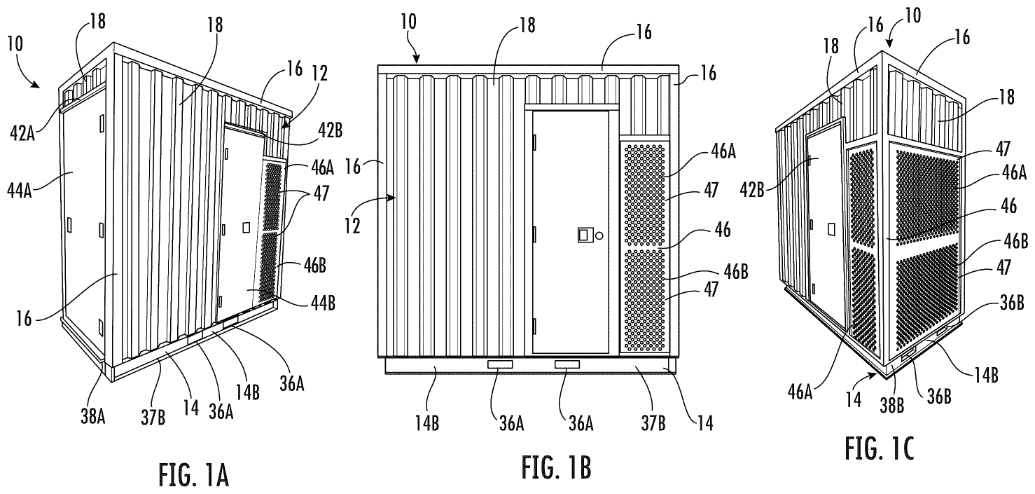

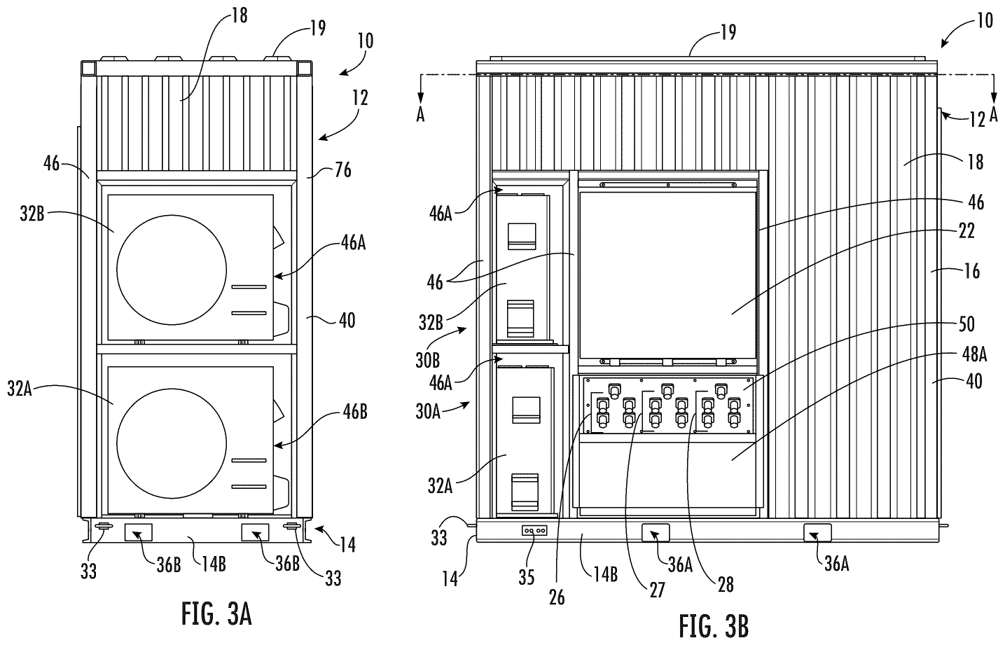

Referring to FIGS. 1A-1C, 2A-2E, and 3A-3B, a mobile automatic switching power backup system, generally 10, for providing uninterruptible power supply capabilities to electronic equipment to which the power backup system 10 is electrically connected. Generally, the mobile automatic switching power backup system 10 can comprise a power distribution enclosure 12 and an uninterruptible power supply (UPS) unit 20. The power distribution enclosure 12 can comprise a platform 14, a frame 16 secured to the platform 14 and exterior walls 18 that define at least a portion of an interior 12A of the power distribution enclosure 12 for housing the UPS unit 20. The UPS unit 20 that is secured in the interior 12A of the power distribution enclosure 12. The power backup system 10 can also comprise a control panel 22 at least partially within the power distribution enclosure 12, and an automatic transfer switch (ATS) unit 24 located within the control panel 22 and operably connected to the UPS unit 20. Additionally, the power backup system 10 can comprise sets of electrical connectors 26, 27, 28 fed into the control panel 22 and in operable communication with the ATS unit 24 as shown in FIG. 3B. For example, the first set of the electrical connectors 26 can comprise input connectors to receive power from an outside utility power source. The second set of the electrical connectors 27 can comprise input connectors to receive power from a generator. The third set of the electrical connectors 28 can comprise output connectors for providing power to equipment receiving power from the backup power system. Additionally, the mobile automatic switching power backup system 10 can comprise one or more heating, ventilation, and air-conditioning (HVAC) units 30A, 30B within the power distribution enclosure 12 to provide temperature control within the interior 12A of the power distribution enclosure 12. Each of the one or more HVAC units 30A, 30B can comprise an outdoor condenser unit 32A, 32B secured in the frame 16 of the power distribution enclosure 12 in an exterior condenser unit frame 46 that is separated from the interior 12A of the power distribution enclosure 12 and an indoor unit 34A, 34B secured within the interior 12A of the power distribution enclosure 12.

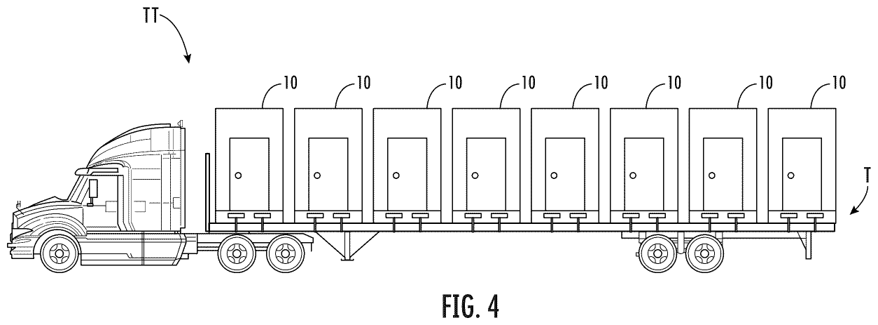

As shown in FIG. 4, the power distribution enclosure 12 of the backup power system 10 can be designed to fit multiple power backup systems 10 on a single standard flatbed trailer T of a tractor-trailer truck TT. For example, in some embodiments, the power distribution enclosure 12 can be about 4 feet wide by about 8 feet deep by about 8 feet tall so that the power distribution enclosure 12 fits on a standard flatbed trailer T and remains under transportation height restrictions. Due to the size of the power distribution enclosures 12, the power backup system 10 can meet transportation weight and height requirements. The power backup system 10 can be operated directly from the truck bed T or can be easily forklifted into any position where backup power is needed.

For example, in some embodiments, the dimensions of the power distribution enclosure 12 can be such that up to 8 units can be fit on a single standard trailer T. In some embodiments, the dimensions of the power distribution enclosure 12 can be such that up to 6 units can be fit on a single standard trailer T.

The ATS unit 24 can be configured to switch from a utility power supply to a power supply of the UPS unit 20 and activating the generator upon detecting a power supply failure from the outside utility power source. Upon the generator reaching a desired power supply level, the ATS unit 24 can be configured to switch from the power supply of the UPS unit 20 to a power supply of the generator.

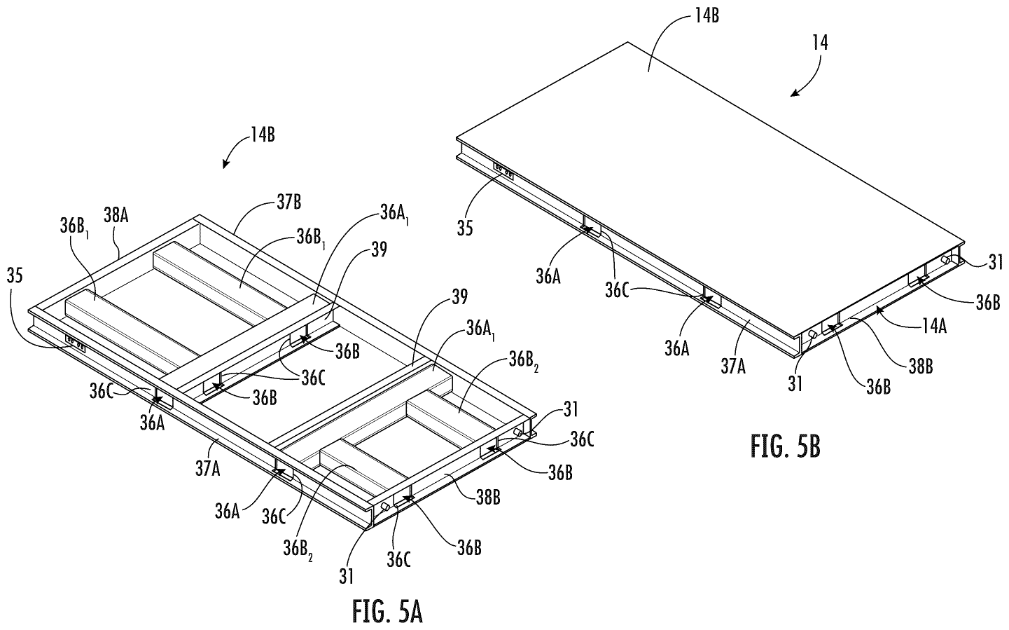

Referring to FIGS. 5A and 5B, the platform 14 of the power distribution enclosure 12 can comprise a platform frame 14A that provides a strength and rigidity to the platform 14. The platform frame 14A can comprise fork channels 36A that extend from a first side 37A to a second side 37B of the platform frame 14A. Additionally, the platform 14A can comprise fork channels 36B that extend inward from a first end 38A and inward from a second end 38B of platform frame 14A. In some embodiments, the first and second sides 37A, 37B and the first and second ends 38A, 38B can comprise U-shape steel channel beams welded together to form a rectangular shape with fork apertures 36C cut therein corresponding to the respective fork channels 36A, 36B. In some embodiments, each of the fork channels 36A can comprise metal channel tubing 36A₁ that extend from the first side 37A to the second side 37B with a U-shape steel channel beam brace 39 welded to the first and second sides 37A, 37B on inner facing sides of the metal channel tubings 36A₁. The fork channels 36B on the first end 37A can comprise metal channel tubings 36B₁ that can extend from the first end 38A to an outer facing side of the closest metal channel tubing 36A₁ and metal channel tubings 36B₂ that can extend from the second end 38B to an outer facing side of the closest metal channel tubing 36A₁. The respective metal channel tubings 36A₁ and U-shape steel channel beam braces 39 can have fork apertures 36C cut therein corresponding to the fork channels 36B of the respective metal channel tubings 36B₁, 36B₂. With such a structure of the platform frame 14A, the power distribution enclosure 12 can be engaged and lifted by a forklift on either side 37A, 37B or either end 38A, 38B.

The platform 14 can comprise a floor plate 14B that can be secured to a top of the platform frame 14A. The floor plate 14B can form the floor with a flat surface of the power distribution enclosure 12. Additionally, the platform frame 14A can comprise a stainless steel grounding pad 35 to provide a ground to the power distribution enclosure 12 and the power backup system 10 as a whole. In some embodiments, the platform frame 14A can comprise tie-down rings 31 on the first and second ends 38A, 38B.

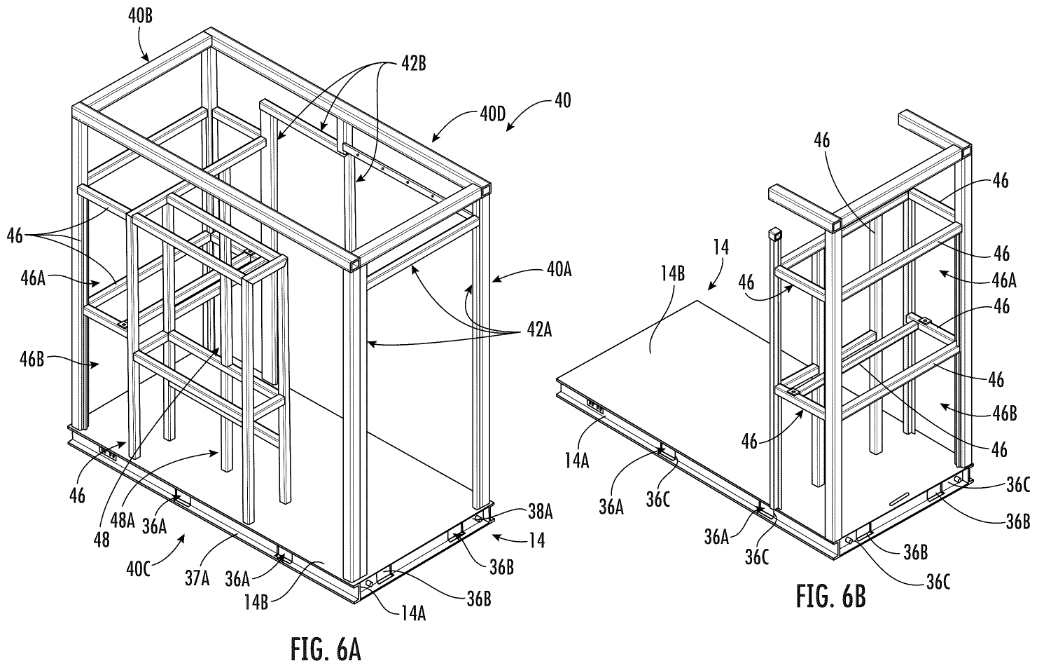

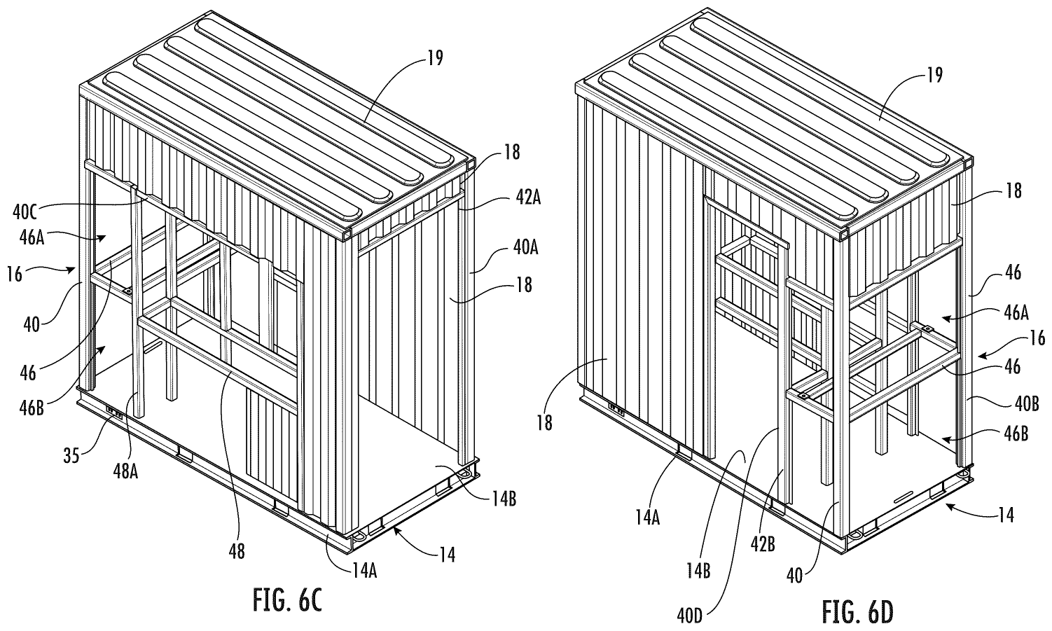

Referring to FIGS. 6A-6D, the frame 16 of the power distribution enclosure 12 comprises an enclosure frame 40 that provides structural stability to the exterior walls 18 of the power distribution enclosure 12. The enclosure frame 40 can have a first end 40A that can form a door frame 42A for a front door 44A that provides access to a front portion of the interior 12A of the power distribution enclosure 12 to provide access to a front of the UPS unit 20. The enclosure frame 40 can comprise a second end 40B that comprises an HVAC frame 46 for supporting the outdoor condenser units 32A, 32B of the HVAC units 30A, 30B. The HVAC frame 46 can be configured such that is forms a first condenser compartment 46A and a second condenser compartment 46B such that one outdoor condenser unit 32A resides in the first condenser compartment 46A and one outdoor condenser unit 32B resides in the second condenser compartment 46B. The HVAC frame 46 can be configured such that one outdoor condenser unit 32B resides above the other outdoor condenser unit 32A with space therebetween. Such that the outdoor condenser units 32A, 32B are inside the enclosure frame 40 but exterior of the power distribution enclosure 12 having access to outside, or environmental, air flow to pull air across condenser coils of the outdoor condenser units 32A, 32B. The enclosure frame 40 can have a first side 40C that can comprise a control panel frame 48 for housing the control panel 22. Additionally, the enclosure frame 40 can comprise a second side 40D comprising a side door frame 42B for a door 44B that provides access to a rear portion of the interior 12A of the power distribution enclosure 12 to provide access to a side and rear portion of the UPS unit 20. The enclosure frame 40, the door frames 42A, 42B, the HVAC frame 46, and control panel frame 48 can comprise metal tubing that has enough structural stability and rigidity to support the exterior walls 18 and the respective doors 44A, 44B, outdoor condenser units 32A, 32B, and control panel 22. Additionally, the power distribution enclosure 12 can comprise a corrugated roof 19 secured to the frame 16 of the power distribution enclosure 12 to improve strength and drainage. The roof 19 can be similar to the roofing used on shipping containers.

As shown in FIGS. 1A-1C, the exterior walls 18 secured to the HVAC frame 46 can comprise a grated metal sheet material 47 that permits air flow therethrough. For example, the grated metal sheet material 47 can comprise expanded metal sheets, perforated metal sheets, metal mesh sheets, or the like. The grated metal sheet material 47 can provide airflow from the surrounding environment so that the fans of the outdoor condenser units 32A, 32B can pull air across the condenser coils of the outdoor condenser units 32A, 32B. At the same time, the grated metal sheet material 47 prevents trash and large environmental debris from entering the HVAC frame 46 that could damage the outdoor condenser units 32A, 32B.

As shown in FIGS. 1A-1C and 6C-6D, at least a portion of the exterior walls 18 secured to portions of the frame 16 comprise at least one of a structural steel, a corrugated steel, or a weathering steel. Such steel exterior walls 18 can provide a tough steel envelope to prevent damage to interior electrical components, such as the UPS unit 20 and the related connections to the ATS unit 24 which can reside in the control panel 22.

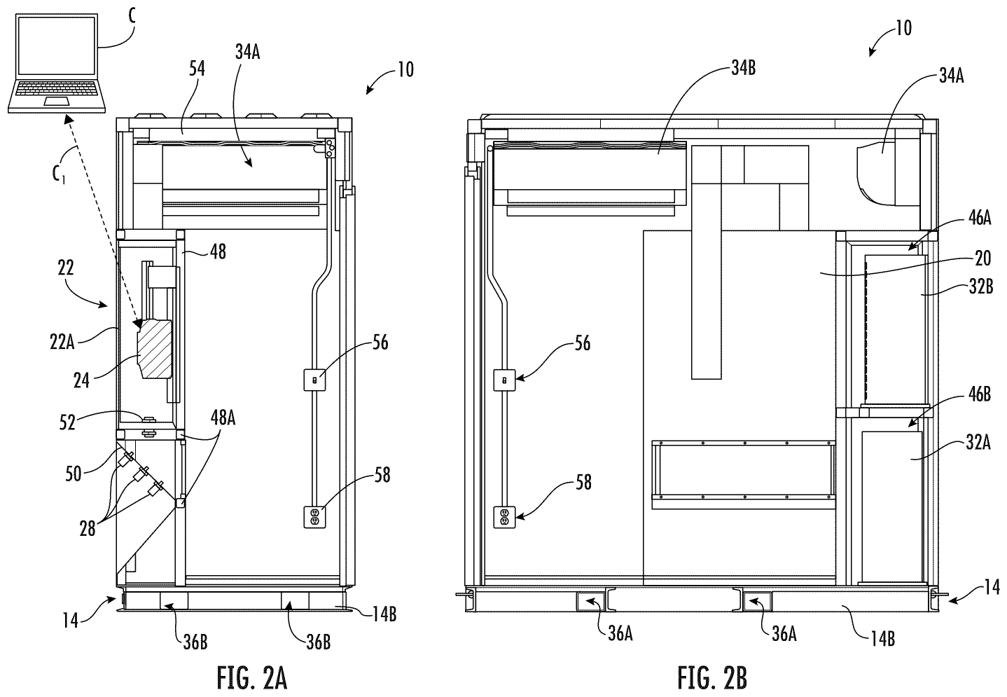

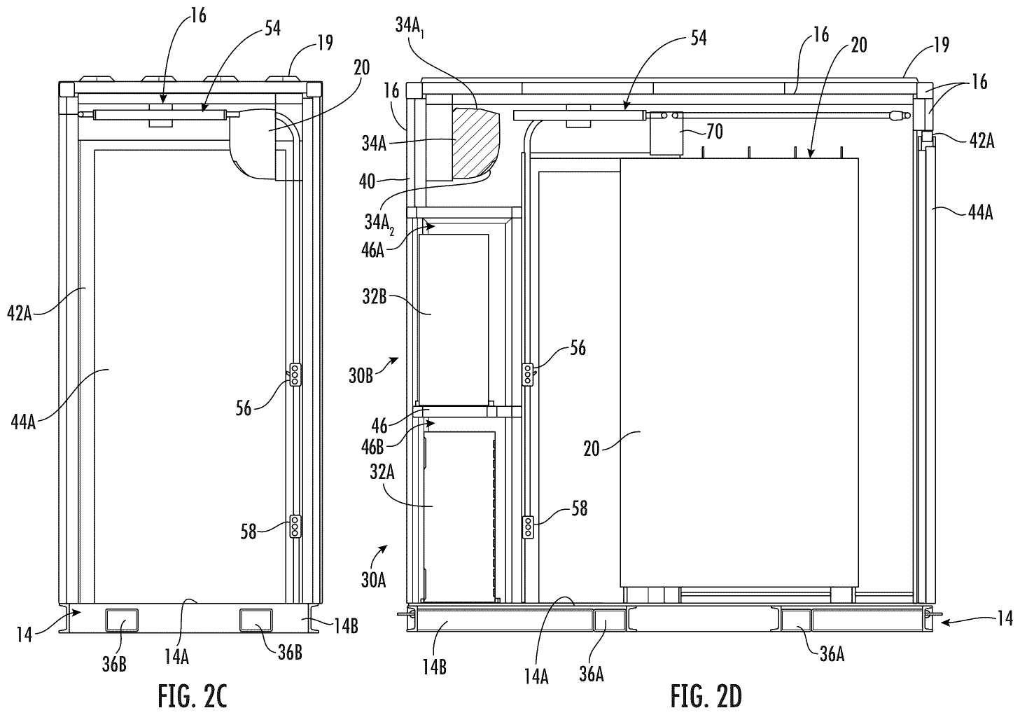

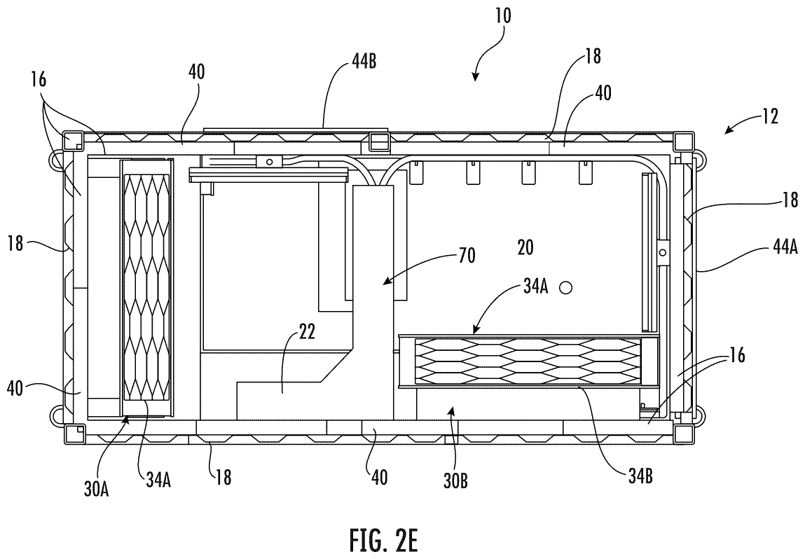

As stated above, the control panel frame 48 is configured to hold the control panel 22. The control panel 22 can house the ATS unit 24 and other controls that can help run the power backup system to effectively connect the utility power supply, a generator, and production equipment or other electronic equipment to the ATS unit 24 and the UPS unit 20 to provide an uninterruptible power supply in case of a utility power supply failure. For example, some of the controls within the control panel 22 may be one or more computing devices to help operate and monitor the UPS unit 20, the ATS unit 24, and the one or more HVAC units 30A, 30B. As shown in FIG. 2A, the control panel 22 can have an exterior accessible door 22A to provide protectable access to the controls and the ATS unit 24.

The control panel frame 48 can include a connector plate portion 48A in which a connector plate 50 can be secured within the power distribution enclosure 12. As shown in FIGS. 2A and 3B, the connector plate 50 can have the sets of electrical connectors 26, 27, 28 secured thereon to provide electrical connections of the utility power supply and the generator to the mobile power backup system 10 and to the ATS unit. The connector plate 50 can also have the set of electrical connectors 28 secured thereon to provide electrical connections of the output to the production equipment or other electronic equipment to which the mobile power backup system 10 is attached. A conduit 52 can be provided to provide passage for wiring associated with the sets of electrical connectors 26, 27, 28 into the control panel for connection to the ATS unit 24. In some embodiments, the connector plate 50 can reside below the control panel 22 in an orientation about parallel to a bottom of the control panel 22. In some embodiments as shown, the connector plate 50 can extend below the control panel 22 at an angle to provide easier access to each of the electrical connectors of the sets of electrical connectors 26, 27, 28.

The interior 12A of the power distribution enclosure 12 can be wired to have lights 54 and light switches 56 therein as well as electrical outlets 58. The lights 54 and the outlets 58 can facilitate operation and maintenance of the UPS unit 20 within the power distribution enclosure 12.

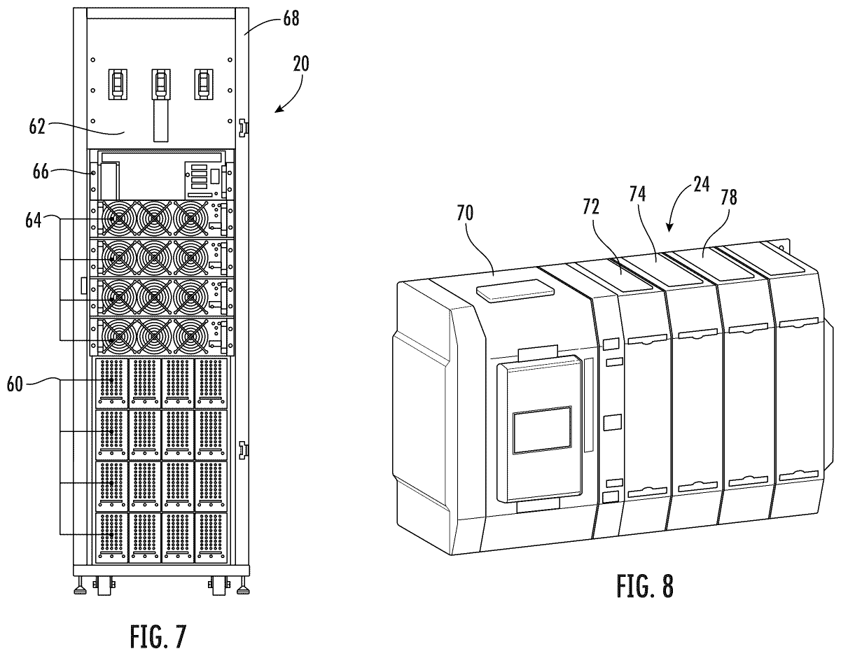

The UPS unit 20 provides the mobile power backup system 10 with the needed power supply to bridge the gap between the time a power failure event occurs with the utility power supply and the time the generator, started by the ATS unit upon detection of the power failure, is up to full load and ready to provide the necessary power to the production or other electronic equipment connected to the mobile power backup system 10. As shown in FIG. 7, the UPS unit 20 comprises one or more batteries 60 secured within the interior of the power distribution enclosure. The batteries 60 can provide the temporary power to bridge the gap between the failure of the utility power supply and the generator being ready to provide the power supply. The UPS unit 20 can also comprise a battery breaker module 62, one or more power modules 64, and a static transfer switch (STS) module 66 to help operate and control the UPS unit 20. In some embodiments, the batteries 60, the battery breaker module 62, one or more power modules 64, and the STS module 66 can be in a single frame 68. Such embodiments, allow for a more compact power distribution enclosure 12. In some embodiments, the batteries 60 can be separate from a frame that holds the battery breaker module 62, one or more power modules 64, and the STS module 66. The UPS unit 20 is configured to deliver a power supply of about 80 kVA at a nominal voltage of about 208 V. As such, the UPS unit 20 can provide about 8 to about 10 minutes of power at about 200 A. In some embodiments, the unit 20 is configured to deliver a power supply of about 100 kVA at a nominal voltage of about 480 V. A transformer (not shown) is needed for such embodiments of the UPS unit to convert the power supply. The transformer can reside in the power distribution enclosure and be operably connected to the UPS unit and the ATS unit.

The UPS unit 20 can comprise an online double conversion UPS unit. For example, the UPS unit 20 can comprise a scalable modular online double conversion UPS unit. The input power from the utility power supply is monitored by the ATS unit 24 and is run through the UPS unit 20 before it is passed through the output connectors 28 to the production or other electronic equipment. In some embodiments, the UPS unit 20 can correct or minimize other problems that may arise with the input power supply, such as voltage spikes or sustained overvoltage, momentary or sustained reduction in input voltage, voltage sag, noise, such as high frequency transient or oscillation, instability of the frequency from the input power supply or harmonic distortion. In some embodiments, the UPS unit 20 may be configured to only provide short-term power when the input power source fails.

As stated above, the ATS unit 24 can automatically determine where power will be received for distributing to the production or other electronic equipment connected to the mobile power backup system 10. As stated, the electric connectors 26, 27, 28 can be positioned below the control panel 22 and accessible from the exterior of the power distribution enclosure 12 for electrically connecting a utility power supply and a generator to the control panel and the ATS unit and for supplying power to production or other electronic equipment connected to the mobile power backup system 10. As shown in FIG. 8, the ATS unit can comprises a 4-wire, 3-phase ATS unit. Thus, the electrical connectors 26, 27, 28 can comprise connectors for a 4-wire, phase connection as shown in FIG. 3B. The ATS unit 24 can have a control unit 70 that monitors power being supplied through the ATS unit 24 and controls the switching of power supplies if needed. The ATS unit can also comprise switches 72, 74, 78 that can be wired to the sets of electrical connectors 26, 27, 28 and permit switching between the power supplies. The ATS unit 24 can thus be configured to monitor the utility power supply and, when an unacceptable volt drop occurs, switch power supply to the UPS unit and start the generator. The ATS unit 24 can then switch power supply to the generator when the generator reaches a desired output power.

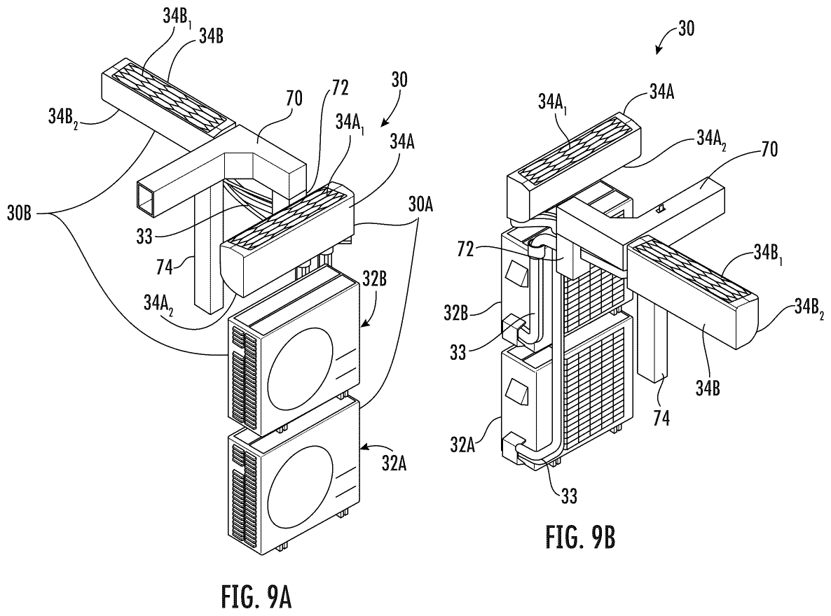

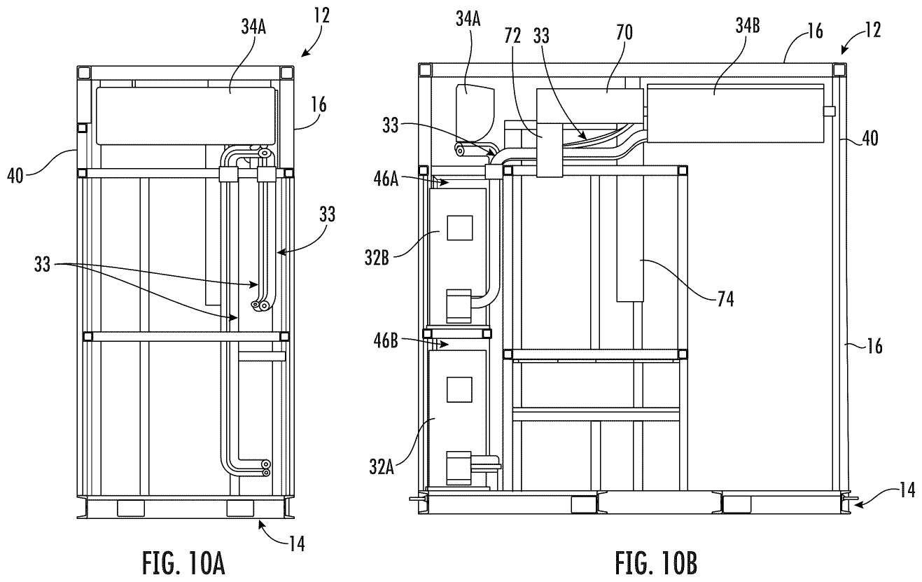

Referring to FIGS. 9A-9B and 10A-10B, the one or more HVAC units 30 can comprise a first HVAC unit 30A comprising a first outdoor condenser unit 32A and a first indoor unit 34A and a second HVAC unit 30B comprising a second outdoor condenser 32B unit and a second indoor unit 34B. The first and second outdoor condenser units 32A, 32B can be connected to first and second indoor units 34A, 34B by standard wiring and fluid conduits 33. Each of the first and second HVAC units 30A, 30B has an individual heating and cooling capacity to maintain the temperature and humidity in the power distribution enclosure 12 when the UPS unit 20 is in operation such that the first and second HVAC units create a redundancy with each HVAC unit capable of carrying the full heating and cooling load for the unit. The batteries 60 and the power modules 64 can generate much heat during operation. In this manner if one of the first and second HVAC units 30A, 30B stops operating, the other of the first and second HVAC units 30A, 30B can be used to maintain the temperature within the interior 12A of the power distribution enclosure 12 and keep the UPS unit 20 within an operating temperature range. Each indoor unit 34A, 34B can comprise an air intake vent 34A₁, 34B₁ and an air outlet vent 34A₂, 34B₂ to provide cooled and dehumidified air or heated air to the interior 12A of the power distribution enclosure 12 to help maintain a proper operating temperature of the UPS unit 20.

To maintain the temperature of the UPS unit 20 within an operating range, good air flow around the UPS unit 20, especially around the front of the unit can be helpful. In some embodiments, the first indoor unit 34A can be positioned transverse to the second indoor unit 34B within the interior 12A of the power distribution enclosure 12. The positioning of the first and second indoor units 34A, 34B in this manner can allow the air from the outlet vent 34A₂ of the first indoor unit 34A to blow in a different direction from the outlet vent 34B₂ of the second indoor unit 34 to provide the possibility to create more efficient air flow around the UPS unit 20. For example, in some embodiments, the first indoor unit 34A can be positioned at a right angle to the second indoor unit 34B. Additionally, in some embodiments (not shown), the first indoor unit 34A and the second indoor unit 34B can have plenums or ducts in operable communication with air outlet vents 34A₂, 34B₂ and/or the air intake vents 34A₁, 34B₁ of the respective first and second indoor units 34A, 34B to direct air flow within the interior 12A of the power distribution enclosure 12.

The exterior walls 18 can be insulated. With the exterior walls 18 and the HVAC units 30A and 30B, the power backup system 10 can withstand the rigors of varying weather conditions, such as temperatures ranging from about −10° F. to about 110° F.

To help organize and direct the wiring between the controls and ATS unit 24 within the control panel 22 and the interior 12A of the power distribution enclosure 12 for the lights 54, the UPS unit 20, and the HVAC units 30A, 30B, wireways, or troughs, 70, 72, 74 for directing the wiring can be provided. While each of the power backup system 10 can be controlled through manually accessing the controls in the control panel 22 and the ATS unit 22 or the UPS unit 20 through the front or side doors 44A, 44B, the power backup system 10 can be monitored and controlled by an external computing device C through telemetry or a wired or cellular network as well as shown in FIG. 2A. For example, the controls in the control panel 22 and the ATS unit 24 can be monitored and controlled by an external computing device C that is exterior to and remote from the mobile automatic switching power backup system 10. In particular, the controls and the ATS unit 24 can be configured to communicate with an external computing device C via at least one of telemetry, a cellular network, or a wired network. For example, the external computing device C can be connected through a wireless connection C₁.

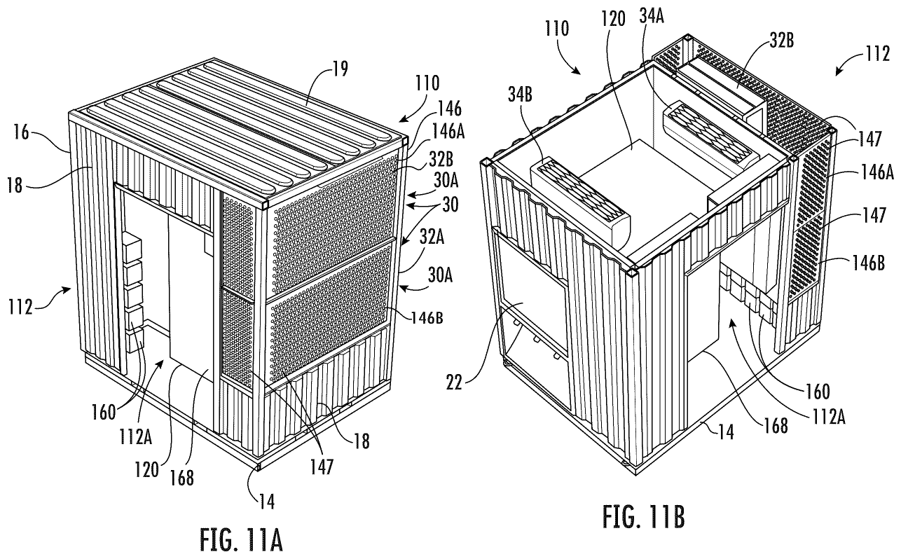

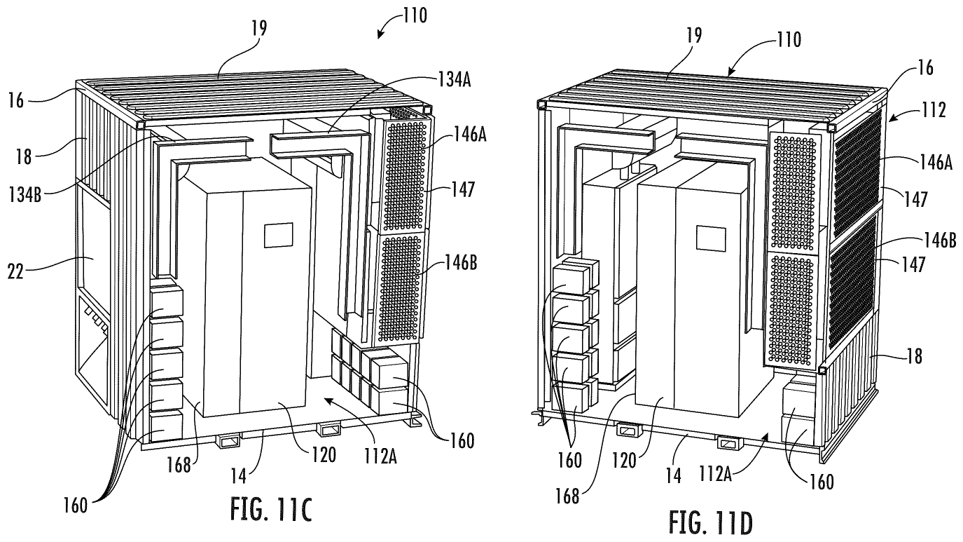

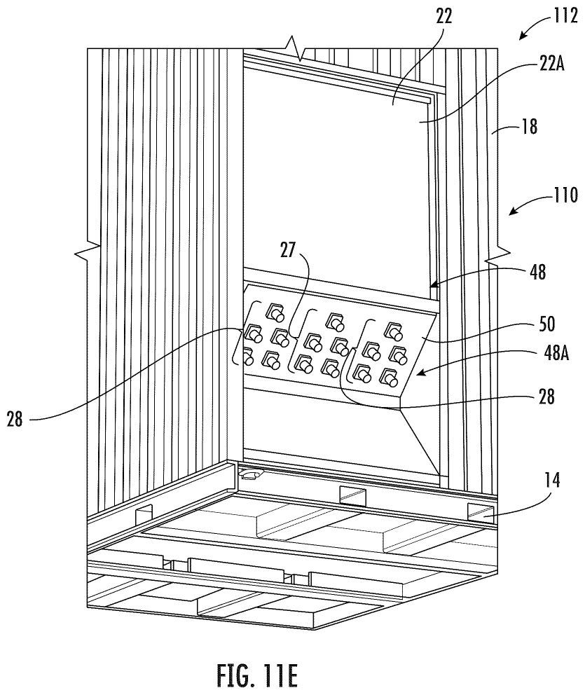

Referring to FIG. 11A-11E, another embodiment of a mobile automatic switching power backup system, generally 110, is provided. The power backup system 110 has a differently shaped power distribution enclosure 112 to accommodate a different UPS unit 120 that has its batteries 160 external to a UPS frame 168. As with the previous embodiments, the power distribution enclosure 112 that comprises a platform 114, a frame 116 secured to the platform 114 and exterior walls 18 that define an interior 112A of the power distribution enclosure 112. In addition to the UPS unit 120, the power backup system 110 can comprise a control panel 22 within the power distribution enclosure 112, and an automatic transfer switch (ATS) unit (not shown) located within the control panel 22 and operably connected to the UPS unit 120. Additionally, the power backup system 110 can comprise sets of electrical connectors 26, 27, 28 fed into the control panel 22 as shown in FIG. 11E and in operable communication with the ATS unit. Additionally, the mobile automatic switching power backup system 110 can comprise two HVAC units 30A, 30B within the power distribution enclosure 112 to provide temperature control within the interior 112A of the power distribution enclosure 112. As above, each of the HVAC units 30A, 30B can comprise an outdoor condenser unit 32A, 32B secured to the frame 16 of the power distribution enclosure 112 and indoor unit 34A, 34B secured within the interior 112A of the power distribution enclosure 112. Other reference numerals identifying similar features above are provided for convenience, but not referenced in this paragraph is made to reduce repetitiveness. The enclosure frame of the frame 116 can include an HVAC frame 146 and a control panel frame 48 that includes a connector plate frame portion 48A that are exterior to the interior 112A of the power distribution enclosure 112. The HVAC frame 146 can be configured such that is forms a first condenser compartment 146A and a second condenser compartment 146B such that one outdoor condenser unit 32A resides in the first condenser compartment 146A and one outdoor condenser unit 32B resides in the second condenser compartment 146B as above. Additionally, as above, the HVAC frame 146 can comprise a grated metal sheet material 147 that permits air flow therethrough.

The UPS unit 120 has the potential to provide more power. With the batteries 160 being external to the UPS frame 168, the UPS unit requires more space. So, the power distribution enclosure 112 needs to provide a larger interior 112A. The batteries 169 can be secured along different walls, including under the frame for the HVAC outside condenser units 32A, 32B.

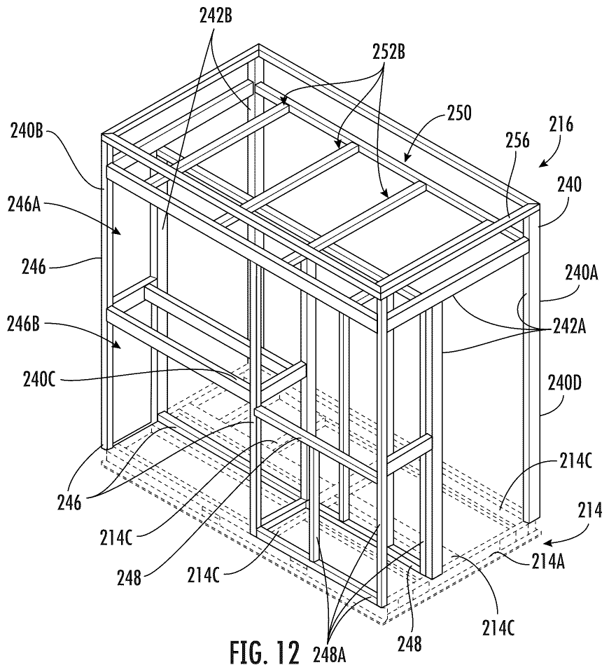

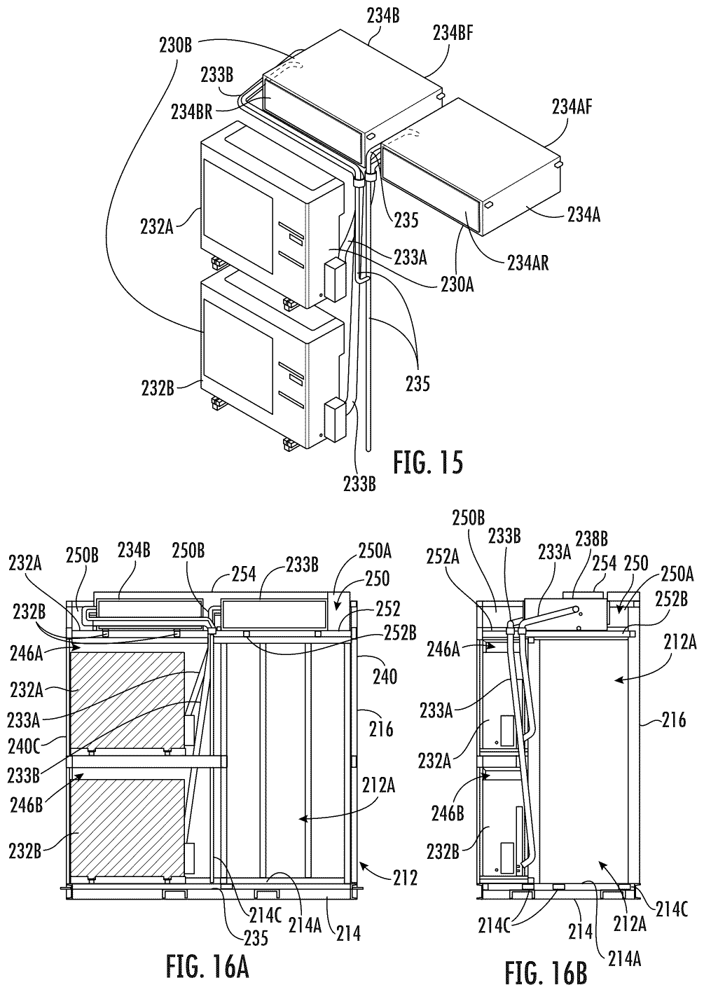

Referring to FIGS. 12-16B, another embodiment of a mobile automatic switching power backup system, generally 210, with a different layout of a power distribution enclosure 212 and HVAC units 230A and 230B is provided. As with the embodiments described above, the power distribution enclosure 212 can have an interior 212A in which an ATS unit and UPS unit can be configured. Additionally, the mobile automatic switching power backup system can have one or more control panels and electrical connections as described above. In particular, this embodiment is provided to illustrate another embodiment of the HVAC units. In some embodiments, the ATS unit, UPS unit, control panel and electrical connections can vary in size, dimensions, configurations, and placement depending on the customer's needs as described above and can be configured within the power distribution enclosure 212 in a variety of ways to meet the customer's needs. Since the ATS unit, UPS unit, control panel and electrical connections are already described above in different configurations, these features are not shown or described in detail in FIGS. 12-16B. As shown in FIG. 15, the first HVAC unit 230A can comprise a first outdoor condenser unit 232A and a first indoor unit 234A and the second HVAC unit 230B comprising a second outdoor condenser 232B unit and a second indoor unit 234B. The first and second outdoor condenser units 232A, 232B can be connected to first and second indoor units 234A, 234B by standard wiring and fluid conduits 233 and a condensate drain 235. Each of the first and second HVAC units 230A, 230B has an individual heating and cooling capacity to maintain the temperature and humidity in the interior 212A of the power distribution enclosure 212 when the UPS unit (not shown) is in operation such that the first and second HVAC units 230A and 230B create a redundancy with each HVAC unit capable of carrying the full heating and cooling load for the unit. The indoor units 234A, 234B can each respectively have a rear intake side 234AR, 234BR with intake vents therein that draw in air to be processed and a front output side 234AF, 234BF with output vents therein that discharge air processed by the respective indoor units 234A, 234B.

As above, the power distribution enclosure 212 can comprise a frame 216 that includes a base platform 214 as shown in FIG. 12. The platform 214 of the power distribution enclosure 212 can comprise a platform frame 214A that can include rigid supports 214C that provide a strength and rigidity to the platform 214. The condensate drain 235 mentioned above can extend through the platform 214 to allow water to drain out of the power distribution enclosure 212. The frame 216 of the power distribution enclosure 212 comprises an enclosure frame interior that provides structural stability to the exterior walls 218 of the power distribution enclosure 212. The enclosure frame 240 can have a first end 240A that can form a door frame 242A for a front door 244A that provides access to a front portion of the interior 212A of the power distribution enclosure 212 and a second end 240B that can form a door frame 242B for a rear door 244B that provides access to a rear portion of the interior 212A of the power distribution enclosure 212. The front and rear doors 224A, 244B can provide access to the UPS unit (not shown) that would reside within of the interior 212A of the power distribution enclosure 212. The enclosure frame 240 can comprise an HVAC frame 246 for supporting the outdoor condenser units 232A, 232B of the HVAC units 230A, 230B. The HVAC frame 246 can be on a first side 240C of the enclosure frame 240. The HVAC frame 246 can be configured such that is forms a first condenser compartment 246A and a second condenser compartment 246B such that one outdoor condenser unit 232A resides in the first condenser compartment 246A and one outdoor condenser unit 232B resides in the second condenser compartment 246B. As shown in this embodiment, outdoor condenser unit 232A resides above the other outdoor condenser unit 232B with space therebetween. Such that the outdoor condenser units 232A, 232B are inside the enclosure frame 240 and the power distribution enclosure 212 but outside the interior 212A of the power distribution enclosure 212 to have access to outside, or environmental, air flow to pull air across condenser coils of the outdoor condenser units 232A, 232B. The enclosure frame 240 can comprise a control panel frame 248 for housing the control panel (not shown) on the first side 240C of the enclosure frame 240. Additionally, the enclosure frame 240 can comprise a second side 240D opposite the first side 240C. The enclosure frame 240, the door frames 242A, 242B, the HVAC frame 246, and control panel frame 248 can comprise metal tubing that has enough structural stability and rigidity to support the exterior walls 218 and the respective doors 244A, 244B, outdoor condenser units 232A, 232B, and control panel (not shown). The control panel frame 248 can include a connector plate frame portion 248A in which a connector plate (not shown) can be secured within the power distribution enclosure 12 such that the control panel and the connector plate are exterior to the interior 212A of the power distribution enclosure 212. The power distribution enclosure 212 can comprise a removable roof 219 that can be secured to the frame 216 of the power distribution enclosure 212 that allows easy access to the indoor unit chamber 250 and the HVAC indoors units 234A and 234B therein. Additionally, the power distribution enclosure 12 can include a wall 217 along the portion of the enclosure frame 240 that includes the control panel frame 248 and the HVAC frame 246 to facilitate the defining of the interior 212A of the power distribution enclosure 212.

As above, the HVAC frame 246 can comprise a grated metal sheet material 47 that permits air flow therethrough. The grated metal sheet material 47 can provide airflow from the surrounding environment so that the fans of the outdoor condenser units 232A, 232B can pull air across the condenser coils of the outdoor condenser units 232A, 232B. At the same time, the grated metal sheet material 47 prevents trash and large environmental debris from entering the HVAC frame 246 that could damage the outdoor condenser units 232A, 232B.

As shown in FIG. 14, the HVAC units 230A and 230B can have the HVAC indoors units 234A and 234B that are positioned in an upward position and reside in an indoor unit chamber 250 that is above and separated from the interior 212A of the power distribution enclosure 212. The indoor unit chamber 250 can be formed by a chamber floor 252A that reside on chamber support 252B (see FIG. 12). The chamber support 252B can be part of the enclosure frame 240. In some embodiments, the chamber floor 252A and the chamber support 252B can form a ceiling of the interior 212A of the power distribution enclosure 212. The indoor unit chamber 250 can have the indoor units 234A and 234B both facing in the same direction within the indoor unit chamber 250, such that the rear intake sides 234AR, 234BR of the indoor units 234A, 234B face outward in a first direction and the front output side 234AF, 234BF of the indoor units 234A, 234B face outward in a second direction. In some embodiments, the indoor unit chamber 250 with the indoor units 234A, 234B positioned therein can have an airtight barrier 254 that runs from the chamber floor 252A to the roof 219. The airtight barrier 254 divides the indoor unit chamber 250 into an output airflow plenum 250A and an intake airflow plenum 250B. The airtight barrier 254 can extend over and around the indoor units 234A, 234B so that the front output sides 234AF, 234BF of the indoor units 234A, 234B faces out into the output airflow plenum 250A and the rear intake side 234AR, 234BR faces out into the intake airflow plenum 250B. The airtight barrier 254 can comprise, for example, a metal wall with air tight seals or sealing compounds between the metal wall and the chamber floor 252A and the indoor units 234A, 234B as needed to make it airtight. The airtight barrier 254 can form an airtight fit between the removable roof 219 and the airtight barrier 254 using proper seals and sealing techniques.

The chamber floor 252A can have one or more output vents 260 and one or more intake vents 262 therein that provide airflow accessibility between the interior 212A of the power distribution enclosure 212 and the indoor unit chamber 250. In particular, in the embodiment shown in FIGS. 12-16B, the vents 260 of the chamber floor 252A can comprise output vents 260A, 260B that can distribute air CA processed by the indoor units 234A, 234B and the vents 262 of the chamber floor 252A can comprise intake vents 262A, 262B through which air HA from the interior 212A of the power distribution enclosure 212 enters the indoor unit chamber 250 into intake airflow plenum 250B to enter vents in the rear intake side 234AR, 234BR of indoor units 234A, 234B. Generally, due to the heat generated by the UPS unit during operation, the indoor units 234A, 234B will normally operate to cool the intake air HA so that the output air CA is colder than the intake air HA.

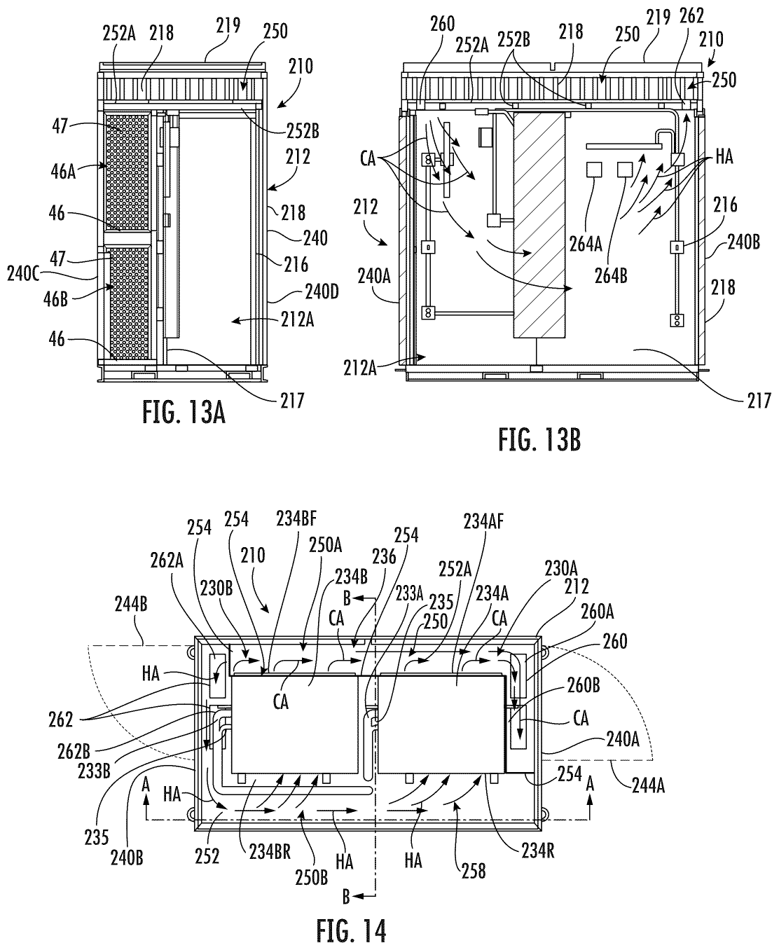

FIGS. 13A and 13B show the indoor unit chamber 250 without the indoor units 234A, 234B and the airtight barrier 254 therein to illustrate that the exterior wall 218 extend upward to form the side walls of the indoor unit chamber 250. FIG. 13B, however, shows the air flow within the interior 212A of the power distribution enclosure 212 that is generated by the indoor units 234A, 234B and the airtight barrier 25. By drawing air in during normal operations through fans in the indoor units 234A, 234B, the indoor units 234A, 234B generates a negative pressure on the intake airflow plenum 250B of the indoor unit chamber 250 to pull air heated by the operating batteries of the UPS unit through the intake vents 262A, 262B. Conversely, the processed and cooled air CA that is output by the indoor units 234A, 234B into the output airflow plenum 250A of the indoor unit chamber 250 generates a positive pressure in output airflow plenum 250A of the indoor unit chamber 250 that pushes the processed air CA, which is colder air than the intake air HA, through the output vents 260A, 260B and back into the interior 212A of the power distribution enclosure 212. The intake vents 262A, 262B and the output vents 260A, 260B can be on opposite sides of the chamber floor 252A so that better air circulation occurs within the interior 212A of the power distribution enclosure 212 and the intake vents 262A, 262B are not stealing cooler air CA that exits the output vents 260A, 260B before the colder air CA has had a chance to circulate within interior 212A of the power distribution enclosure 212. In this manner, good circulation is created within the interior 212A of the power distribution enclosure 212 that can help cool the UPS unit as it generates heat during operation of the backup power supply system 210.

To help monitor the temperatures inside the interior 212A of the power distribution enclosure 212, one or more temperature sensors 264A, 264B, such as thermostats, can be installed in the interior 212A of the power distribution enclosure 212. The temperature sensors 264A, 264B can be in operable communication with the control panel (not shown) and/or the HVAC units 230A and 230B. The temperature sensors 264A, 264B can be used to determine when a temperature within the interior 212A of the power distribution enclosure 212 has been reached to activate the HVAC units 230A and 230B to generate cool air to cool the interior 212A of the power distribution enclosure 212 and the batteries therein. The temperature sensors 264A, 264B can be positioned on a side of the interior 212A of the power distribution enclosure 212 closer to the side 240B of the enclosure frame 240, which is the side of the interior 212A of the power distribution enclosure 212 where the intake vents 262A, 262B takes the heated air with the interior 212A of the power distribution enclosure 212. In some embodiments, as shown in FIG. 13A, the temperature sensors 264A, 264B are on the wall 217 on a side of the interior 212A of the power distribution enclosure 212 closer to the vents 262A, 262B. In some embodiments, the temperature sensors 264A, 264B can be on the side wall adjacent the side 240B of the enclosure frame 240. In some embodiments, the temperature sensors 264A, 264B can be at or near the vents 262A, 262B.

The use of an indoor unit chamber 250 for housing the indoor units 234A, 234B that includes intake vents 262A, 262B and output vents 260A, 260B allows the indoor units 234A, 234B to be in operable communication with the vents 262A, 262B and output vents 260A, 260B. This operable communication allows heated air HA from the interior 212A of the power distribution enclosure 212 to pass through vents 262A, 262B and be drawn into vents in the intake side 234AR, 234BR of indoor units 234A, 234B for processing and cooled processed air CA to be discharged from vents in the output side 234AF, 234BF of indoor units 234A, 234B and through the output vents 260A, 260B back into the interior 212A of the power distribution enclosure 212. In the embodiment shown in FIGS. 12-16B, the airtight barrier 254 is used to form the intake airflow plenum 250B that isolates and directs the air HA received from the interior 212A of the power distribution enclosure 212 to the vents in the rear intake side 234AR, 234BR of indoor units 234A, 234B and the output airflow plenum 250A that isolates and directs the air CA received from the indoor units 234A, 234B through the output vents 260A, 260B back into the interior 212A of the power distribution enclosure 212. Additionally, in some embodiments (not shown), the first indoor unit 234A and the second indoor unit 234B can have ducts, instead of the plenums 250 and 250B in operable communication with air outlet vents in the front output side 234AF, 234BF of the indoor units 234A, 234B and/or the air intake vents in the intake side 234AR, 234BR of indoor units 234A, 234B to direct air flow within the interior 212A of the power distribution enclosure 12.

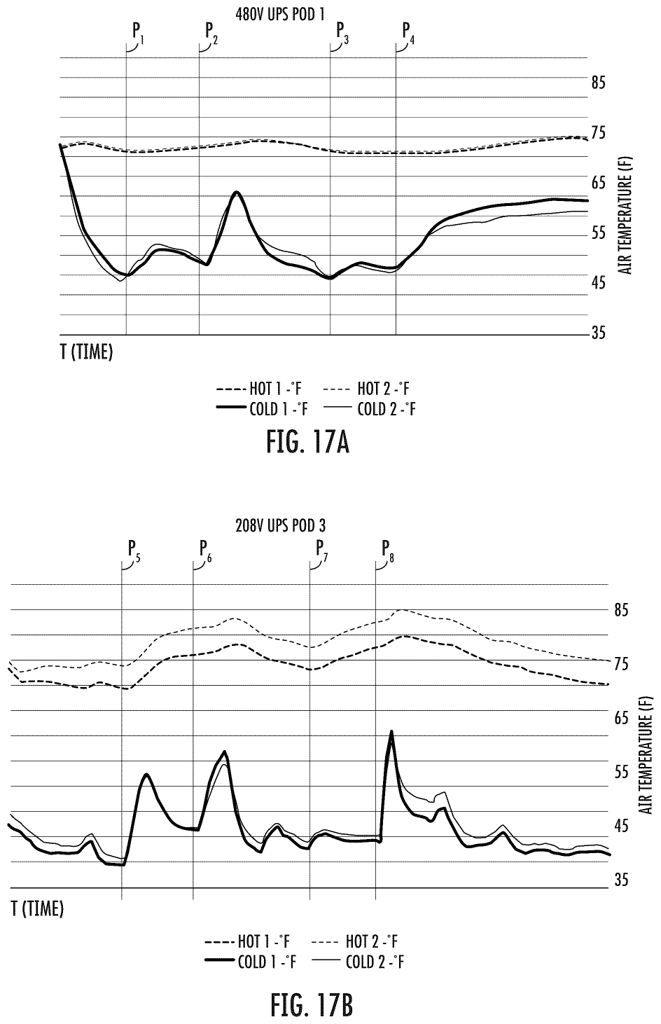

Tests were run to illustrate the temperature control results within the interior 212A of the power distribution enclosure 212 in an embodiment of the automatic switching power backup system 210 as shown in FIGS. 12-16B over time when the UPS unit is activated at different intervals. FIGS. 17A and 17B show that, when the UPS unit was activated in the power backup system 210, the HVAC units 230A and 230B were activated in a manner to regulate the temperature within the interior 212A of the power distribution enclosure 212. Hot 1 and Hot 2 temperature lines represents the temperature of the air entering the intake vents 262A, 262B, respectively, and Cold 1 and Cold 2 temperature lines represents the temperature of the air exiting the output vents 260A, 260B, respectively. FIG. 17A represents a use of a 480V UPS unit and FIG. 17B represents a use of a 208V UPS unit.

As shown in FIG. 17A, P₁ represents an external power loss event with the external power being returned at P₂. As can been in the graph, the temperature of the air at the intake vents 262A, 262B was well maintained while the UPS unit was operating during the loss of external power with the Hot 1 and Hot 2 temperature lines being almost identical. The Cold 1 and Cold 2 temperature lines spiked between P₂ and P₃ to help dissipate the heat generated during the operating of the UPS unit that occurred between P₁ and P₂ to maintain the temperature in the interior 212A of the power distribution enclosure 212. Similarly, P₃ represents an external power loss event with the external power being returned at P₄. As can been in the graph, the temperature of the air at the intake vents 262A, 262B was also well maintained while the UPS unit was operating during the loss of external power with the Hot 1 and Hot 2 temperature lines being almost identical.

As shown in FIG. 17B, P₅ represents an external power loss event with the external power being returned at P₆. As can been in the graph, the temperature of the air at the intake vents 262A, 262B was maintained while the UPS unit was operating during the loss of external power. The Cold 1 and Cold 2 temperature lines spiked between P₅ and P₆ during the operating of the UPS unit and again between P₆ and P₇ to help dissipate the heat generated during the operating of the UPS unit that occurred between P₅ and P₆ to maintain the temperature in the interior 212A of the power distribution enclosure 212. Similarly, P₇ represents an external power loss event with the external power being returned at P₈. As can been in the graph, the temperature of the air at the intake vents 262A, 262B was also well maintained while the UPS unit was operating during the loss of external power with the Hot 1 and Hot 2 temperature lines.

In the foregoing specification, specific examples, features, and aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

What is claimed is:

1. A mobile automatic switching power backup system for providing uninterruptible power supply capabilities, the mobile automatic switching power backup system comprising:
an uninterruptible power supply (UPS) unit;
a power distribution enclosure having a frame including a platform and exterior walls that form an enclosure that includes an interior in which the uninterruptible power supply (UPS) unit is secured;
comprising one or more batteries secured within the interior of the power distribution enclosure;
a control panel within the power distribution enclosure for housing controls of the power backup system;
an automatic transfer switch (ATS) unit located within the control panel and operably connected to the UPS unit;
electrical connectors in operable communication with the ATS unit, the electrical connectors comprising input connectors to receive power from an outside utility power supply, input connectors to receive power from a generator, and output connectors for providing power to equipment receiving power from the power backup system; and
one or more heating, ventilation, and air-conditioning (HVAC) units within the power distribution enclosure, each of the one or more HVAC units comprising an outdoor condenser unit secured in the frame of the power distribution enclosure and indoor unit secured within the power distribution enclosure.

2. The mobile automatic switching power backup system according to claim 1, wherein the frame of the power distribution enclosure comprises an enclosure frame that comprises an HVAC frame for supporting the outdoor condenser units of the one or more HVAC units and a control panel frame for housing the control panel and an electrical connector plate.

3. The mobile automatic switching power backup system according to claim 1, wherein the HVAC frame and the control panel frame are external of the interior of the power distribution enclosure.

4. The mobile automatic switching power backup system according to claim 3, wherein the HVAC frame and the control panel frame are on a first side of the enclosure frame.

5. The mobile automatic switching power backup system according to claim 2, wherein the enclosure frame comprises at least one door frame for a door that accesses the interior of the power distribution enclosure.

6. The mobile automatic switching power backup system according to claim 2, wherein the exterior walls secured to the HVAC frame comprises a grated metal sheet material that permits air flow therethrough.

7. The mobile automatic switching power backup system according to claim 3, wherein the HVAC frame is a first end of the enclosure frame, and the control panel frame is on a first side of the enclosure frame.

8. The mobile automatic switching power backup system according to claim 1, wherein at least a portion of the exterior walls secured to portions of the frame comprise at least one of a structural steel, a corrugated steel, or a weathering steel.

9. The mobile automatic switching power backup system according to claim 1, wherein the control panel comprise an exterior accessible door to access controls in the control panel and the ATS unit.

10. The mobile automatic switching power backup system according to claim 1, wherein the power distribution enclosure comprises a connector plate on which the electrical connectors reside secured to the control panel frame for the control panel.

11. The mobile automatic switching power backup system according to claim 10, wherein the connector plate extends below the control panel at an angle to provide access to each of the electrical connectors.

12. The mobile automatic switching power backup system according to claim 1, wherein the exterior walls of the power distribution enclosure are insulated.

13. The mobile automatic switching power backup system according to claim 1, wherein the UPS unit comprises a battery breaker module, a power module, and a static transfer switch (STS) module.

14. The mobile automatic switching power backup system according to claim 1, wherein the UPS unit is configured to deliver a power supply of about 80 kVA.

15. The mobile automatic switching power backup system according to claim 1, wherein the UPS unit comprises an online double conversion UPS unit.

16. The mobile automatic switching power backup system according to claim 1, wherein the UPS unit comprises a scalable modular online double conversion UPS unit.

17. The mobile automatic switching power backup system according to claim 1, wherein the electrical connectors are positioned below the control panel and accessible from an exterior of the power distribution enclosure for electrically connecting a utility power supply and a generator to the control panel and the ATS unit.

18. The mobile automatic switching power backup system according to claim 1, wherein the ATS unit comprises 4-wire, 3-phase ATS unit.

19. The mobile automatic switching power backup system according to claim 18, wherein the electrical connectors comprise connectors for a 4-wire, phase connection.

20. The mobile automatic switching power backup system according to claim 1, wherein the ATS unit is configured to monitor the utility power supply and, when an unacceptable volt drop occurs, switch power supply to the UPS unit and start the generator; and
wherein, when the generator reaches a desired output power, the ATS unit is configured to switch power supply to the generator.

21. The mobile automatic switching power backup system according to claim 1, wherein the one or more HVAC units comprise a first HVAC unit comprising a first outdoor condenser unit and a first indoor unit and second HVAC unit comprising a second outdoor condenser unit and a second indoor unit.

22. The mobile automatic switching power backup system according to claim 21, wherein each of the first and second HVAC units has an individual heating and cooling capacity to maintain temperature and humidity in the power distribution enclosure when the UPS unit is in operation such that the first and second HVAC units create a redundancy with each HVAC unit capable of carrying a full heating and cooling load for the power backup system.

23. The mobile automatic switching power backup system according to claim 21, wherein the first and second indoor units reside in the interior of the power distribution enclosure.

24. The mobile automatic switching power backup system according to claim 21, wherein the enclosure of the power distribution enclosure comprises an indoor unit chamber that is external to the interior of the power distribution enclosure in which the first and second indoor units reside.

25. The mobile automatic switching power backup system according to claim 24, wherein the indoor unit chamber comprises a chamber floor with one or more intake vents and one or more output vents therein.

26. The mobile automatic switching power backup system according to claim 24, wherein the indoor unit chamber comprises an airtight barrier that forms an output airflow plenum in operable communication with one or more output vents and an intake airflow plenum in operable communication with one or more intake vents.

27. The mobile automatic switching power backup system according to claim 1, wherein the controls in the control panel and the ATS unit are monitored and controlled by an external computing device that is exterior to and remote from the mobile automatic switching power backup system.

28. The mobile automatic switching power backup system according to claim 27, wherein the controls and the ATS unit are configured to communicate with an external computing device via at least one of telemetry, a cellular network, or a wired network.

29. The mobile automatic switching power backup system according to claim 1, further comprising a transformer residing in the power distribution enclosure, the transformer being operably connected to the UPS unit and the ATS unit.

30. A method of using the mobile automatic switching power backup system according to claim 1, the method further comprising:
detecting a power supply failure from the outside utility power supply using the ATS unit;
switching power supply to the UPS unit using the ATS unit;
activating the generator using the ATS unit; and
upon the generator reaching a desired power supply level, switching the power supply from the UPS unit to the generator using the ATS unit.

31. The method according to claim 30, further comprising:
monitoring the utility power supply using the ATS unit and, when an unacceptable volt drop occurs, switch power supply to the UPS unit and start the generator; and
upon the generator reaching a desired output power, switching power supply to the generator using the ATS unit.

32. A mobile automatic switching power backup system for providing uninterruptible power supply capabilities, the mobile automatic switching power backup system comprising:
a power distribution enclosure comprising a frame with a platform and exterior walls that form an enclosure with an interior;
an uninterruptible power supply (UPS) unit comprising one or more batteries secured within the interior of the power distribution enclosure;
a control panel within the power distribution enclosure for housing controls of the power backup system;
an automatic transfer switch (ATS) unit located within the control panel and operably connected to the UPS unit;
electrical connectors in operable communication with the ATS unit, the electrical connectors comprising input connectors to receive power from an outside utility power supply, input connectors to receive power from a generator, and output connectors for providing power to equipment receiving power from the power backup system; and
one or more heating, ventilation, and air-conditioning (HVAC) units within the power distribution enclosure, each of the one or more HVAC units comprising an outdoor condenser unit secured to the frame of the power distribution enclosure and indoor unit secured within the power distribution enclosure; and
the ATS unit configured, upon detecting a power supply failure from the outside utility power supply, switching power supply to the UPS unit, and activating the generator, and, upon the generator reaching a desired power supply level, switching the power supply from the UPS unit to the generator.

33. The mobile automatic switching power backup system according to claim 32, wherein the platform of the power distribution enclosure comprises a platform frame comprising fork channels that extend from a first side to a second side of the platform frame configured to be engaged by forks of a forklift and fork channels that extend inward for a first end and a second end of the platform frame and a floor plate secured to a top of the platform frame to form a floor of the power distribution enclosure.

34. The mobile automatic switching power backup system according to claim 33, wherein the platform frame comprises a stainless steel grounding pad.

35. The mobile automatic switching power backup system according to claim 33, wherein the platform frame comprises tie-down rings on the first and second ends.

36. The mobile automatic switching power backup system according to claim 32, wherein the one or more HVAC units comprise a first HVAC unit comprising a first outdoor condenser unit and a first indoor unit and second HVAC unit comprising a second outdoor condenser unit and a second indoor unit.

37. The mobile automatic switching power backup system according to claim 36, wherein the first and second indoor units reside in the interior of the power distribution enclosure.

38. The mobile automatic switching power backup system according to claim 36, wherein the enclosure of the power distribution enclosure comprises an indoor unit chamber that is external to the interior of the power distribution enclosure in which the first and second indoor units reside.

39. The mobile automatic switching power backup system according to claim 38, wherein the indoor unit chamber comprises a chamber floor with one or more intake vents and one or more output vents therein.

40. The mobile automatic switching power backup system according to claim 38, wherein the indoor unit chamber comprises an airtight barrier that forms an output airflow plenum in operable communication with one or more output vents and an intake airflow plenum in operable communication with one or more intake vents.

41. The mobile automatic switching power backup system according to claim 32, wherein the power distribution enclosure comprises a connector plate secured to the control panel frame of the control panel on which the electrical connectors reside, wherein the connector plate extends below the control panel at an angle to provide access to each of the electrical connectors.

42. The mobile automatic switching power backup system according to claim 32, wherein the UPS unit comprises a battery breaker module, a power module, and a static transfer switch (STS) module.

43. The mobile automatic switching power backup system according to claim 32, wherein the UPS unit comprises a scalable modular online double conversion UPS unit.

44. The mobile automatic switching power backup system according to claim 32, wherein the electric connectors are positioned below the control panel and accessible from the exterior of the power distribution enclosure for electrically connecting a utility power supply and a generator to the control panel and the ATS unit.

45. The mobile automatic switching power backup system according to claim 32, wherein the ATS unit comprises 4-wire, 3-phase ATS unit, wherein the electrical connectors comprise connectors for a 4-wire, phase connection.

46. The mobile automatic switching power backup system according to claim 32, wherein the controls in the control panel and the ATS unit are monitored and controlled by an external computing device that is exterior to and remote from the mobile automatic switching power backup system.

47. The mobile automatic switching power backup system according to claim 32, further comprising a transformer residing in the power distribution enclosure, the transformer being operably connected to the UPS unit and the ATS unit.
